(19) United States
(12) Patent Application Publication
(10) Pub. No.: US 2020/0247219 A1
(43) Pub. Date: Aug. 6, 2020

(54) HVAC SYSTEM INCLUDING AN IONIZER

(71) Applicant: Calsonic Kansei North America, Inc., Farmington Hills, MI (US)

(72) Inventor: Aaron Joseph Kleinow, Clarkston, MI (US)

(21) Appl. No.: 16/268,614

(22) Filed: Feb. 6, 2019

(51) Int. Cl. B60H 3/00; B60H 1/00; B60H 1/22

(52) U.S. Cl. CPC B60H 3/0078; B60H 2001/224; B60H 1/2218; B60H 1/008

(57) ABSTRACT

An HVAC system for a vehicle includes an evaporator, an ionizer, and an HVAC controller. The evaporator is configured to cool air. The ionizer is disposed in the HVAC system downstream from the evaporator and configured to ionize the cool air prior to disbursing the cool air into an environment. The HVAC controller determines a state of the air in the HVAC system. The HVAC controller determines whether a condition is present based on the state of the air in the HVAC system. When the condition is present, the HVAC controller activates the ionizer to ionize the air from the evaporator prior to the air being disbursed into the environment.

### BACKGROUND

The present application relates generally to the field of heating, ventilation, and air conditioning (“HVAC”) systems for vehicles.

Many vehicles include HVAC systems. An HVAC system typically includes an element, such as an evaporator, configured to cool air. A blower arranged upstream from the evaporator blows air across the evaporator. As the air passes the evaporator, the air is cooled. The cooled air is then disbursed into the vehicle's cabin. In some instances, the environmental conditions may cause the air blown across the evaporator and into the cabin to have a stale air smell. For example, it is known that if an evaporator operates at a temperature greater than 10 degrees Celsius, a stale air smell can result within the passenger compartment.

It would therefore be advantageous to provide an HVAC system to prevent or inhibit the stale air smell.

### SUMMARY

One embodiment relates to an HVAC system for a vehicle. The HVAC system includes an evaporator, an ionizer, and an HVAC controller. The evaporator is configured to cool air. The ionizer is disposed in the system downstream from the evaporator and configured to ionize the cool air prior to disbursing the cool air into an environment. The HVAC controller is communicably coupled to the evaporator and the ionizer. The HVAC controller is configured to determine an exit temperature of air from the evaporator. The HVAC controller is further configured to compare the determined exit temperature to a stale air threshold. The HVAC controller is further configured to activate the ionizer to ionize the air from the evaporator prior to the air being disbursed into the environment responsive to the determined exit temperature exceeding the stale air threshold.

Another embodiment relates to a method of controlling an HVAC system. The method includes determining a state of air in the HVAC system. The method includes determining, based on the state of the air, whether a condition is present which prompts activation of an ionizer. The method includes activating the ionizer arranged downstream from the evaporator responsive to the condition being present. The ionizer ionizes the air from the evaporator prior to the air being disbursed into the environment.

Another embodiment relates to a method of controlling an HVAC system. While an HVAC system is running, the method includes a) determining an exit temperature of air downstream from an evaporator. The method further includes b) comparing the exit temperature to a stale air threshold. The method further includes c) when the determined exit temperature exceeds a stale air threshold, activating an ionizer to ionize air downstream from the evaporator prior to the air being disbursed into the environment. The method further includes, while performing c) monitoring a duration which the ionizer is active. The method further includes, when the duration exceeds a time threshold, repeating steps a) through b) until the exit temperature is less than the stale air threshold, whereby the ionizer is deactivated when the exit temperature is less than the stale air threshold.

### BRIEF DESCRIPTION OF THE DRAWINGS

FIG. 1 is a schematic view of an HVAC system, according to an exemplary embodiment.

FIG. 2 is an example arrangement of the HVAC system of FIG. 1.

FIG. 3 is a flowchart showing an example method of controlling an HVAC system.

### DETAILED DESCRIPTION

Referring to the FIGURES generally, an HVAC system for a vehicle is shown and described according to various exemplary embodiments. It should be noted that the HVAC system as shown is configured as an air conditioner without a heater, but that the term “HVAC system” is being used to refer generally to systems which deliver air in a vehicle and are configured to control the temperature of the air. Further it should be understood that the HVAC system may be configured with both a heater and an evaporator according to various exemplary embodiments.

In some conventional HVAC systems, when a user (such as a vehicle occupant) inputs or otherwise provides a desired cabin temperature or a defrost or dehumidification input to the HVAC system, the evaporator may first cool the air to temperatures well below the desired cabin temperature (such as between 0-1° C.), after which a heater may be employed to heat the air to the desired cabin temperature. The heater may be arranged downstream from the evaporator. Hence, air which is to be cooled to a desired cabin temperature is first cooled to temperatures well below the desired cabin temperature, then heated to the desired cabin temperature. Such HVAC systems are configured in this manner in an effort to eliminate a stale air smell which might be present if the evaporator directly output air at temperatures above a stale air temperature (e.g., above 10° C.). One disadvantage of such systems is that the initial cooling and subsequent heating of the air increases energy consumption within the vehicle, resulting in a potentially inefficient HVAC system (and, ultimately, decreased fuel or battery efficiency).

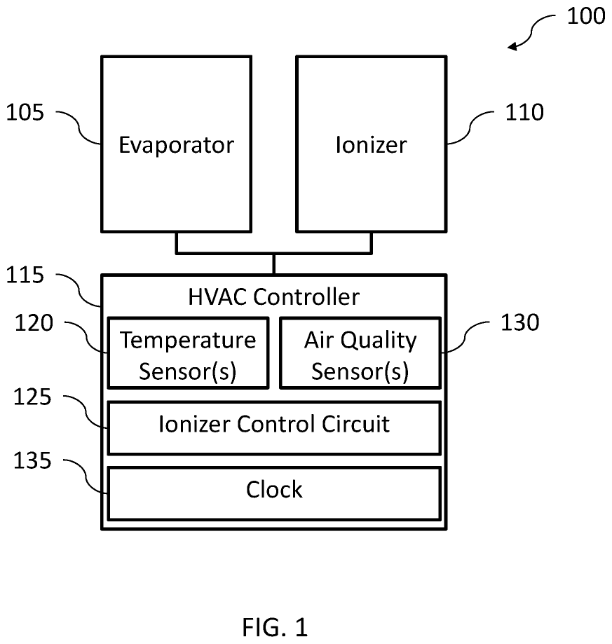

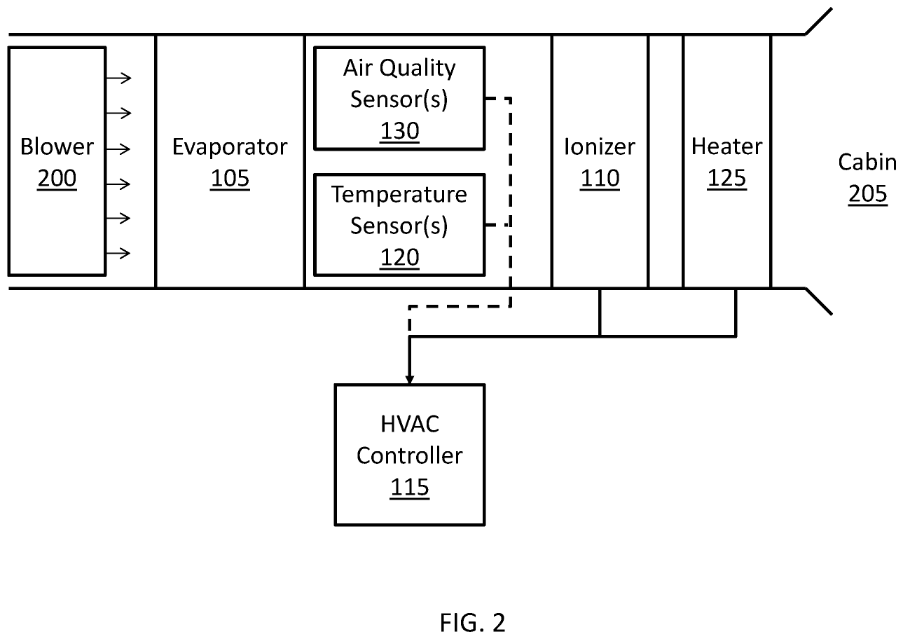

Referring now to FIG. 1, a schematic view of an improved HVAC system 100 (hereinafter the “system”) is shown according to an exemplary embodiment. The system 100 includes an evaporator 105, an ionizer 110, and an HVAC controller 115. As described in greater detail below, the evaporator 105 is configured to cool air that is to be disbursed into an environment, such as a cabin of a vehicle. The ionizer 110 is configured to ionize air from the evaporator 105 prior to the air being disbursed into the environment. The HVAC controller 115 includes or is communicably coupled to various components within the system 100. The HVAC controller 115 may include or be communicably coupled to a temperature sensor 120. The HVAC controller 115 may determine an exit temperature for air downstream from the evaporator 105 via the temperature sensor 120. The HVAC controller 115 may compare the exit temperature to a stale air threshold. When the exit temperature exceeds the stale air threshold, the HVAC controller 115 may automatically activate the ionizer 110 to ionize air downstream from the evaporator 105 prior to the air being disbursed into the environment (e.g., the cabin 205 of FIG. 2).

The embodiments described herein may act to reduce or eliminate the stale air smell caused by environmental conditions resulting from an evaporator discharging air at temperatures above a stale air temperature. Specifically, the ionizer may ionize the air prior the air being disbursed into the cabin 205. As the air is ionized, negative ions are attached to particles in the air which may then become attracted to grounded conductors (e.g., in the duct work or in the ionizer, for instance). The particles are thus removed from the air prior to the air being disbursed into the cabin 205. Additionally, the embodiments described herein may conserve energy or otherwise increase efficiency with respect to the aforementioned HVAC systems by eliminating the additional cooling/heating cycle implemented in such systems. Such increased energy efficiency may be particularly beneficial when the system 100 described herein is incorporated into or otherwise included in an electric vehicle.

Referring now to FIG. 1 and FIG. 2, the system 100 will now be described in greater detail. Specifically, FIG. 2 is a schematic illustration that depicts one possible arrangement of the HVAC system 100 according to an exemplary embodiment. The evaporator 105 may be any device, component, or group of devices or components configured to cool air. The evaporator 105 may include an internal coil system including a refrigerant liquid (e.g., R1234yf, R134a, or other types of refrigerant liquids which may be used in HVAC systems, whether now known or hereafter developed). The evaporator 105 may also include various fins (or other increased surface area devices or components). The evaporator 105 may be configured to convert the refrigerant liquid in the internal coil system to gas (e.g., via a compressor). As the refrigerant liquid is converted to gas, such conversion may cause the coils (and the fins) to absorb heat from air surrounding (or passing through, across, etc.) the evaporator 105. For instance, the system 100 may include a blower 200 (or fan) arranged upstream from the evaporator 105. The blower 200 may blow air across the evaporator 105, and the evaporator 105 may cool the air blown across the evaporator 105. Hence, the evaporator 105 may cool air (e.g., blown across the evaporator 105 by the blower 200) by converting refrigerant liquid to gas.

The system 100 includes an HVAC controller 115. The controller 115 may be or include a component or group of components configured to perform various functions for the system 100. In some embodiments, the HVAC controller 115 may be included in or a component of the electronic control unit (ECU) of the vehicle. The HVAC controller 115 may include a processor and memory. The processor may be a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. The processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The memory (e.g., memory, memory unit, storage device) may include one or more devices (e.g., RAM, ROM, EPROM, EEPROM, optical disk storage, magnetic disk storage or other magnetic storage devices, flash memory, hard disk storage, or any other medium) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The HVAC controller 115 may be configured to activate the evaporator 105 based on commands from a user. For instance, a user may provide various inputs (e.g., via buttons, knobs, touch screen, or other input device) to a climate control system of the vehicle. Some inputs may correspond to cooling the cabin 205 of the vehicle to a desired temperature. The inputs may correspond to dehumidifying or defrosting the windows within the vehicle. The HVAC controller 115 may be communicably coupled to various temperature sensors (including but not limited to the temperature sensor(s) 120) in the vehicle. Such temperature sensor(s) may be configured to generate data corresponding to the current cabin 205 temperature for the vehicle. The HVAC controller 115 may be configured to determine whether the desired temperature is greater than or less than the current cabin 205 temperature. Where the desired temperature is less than the current cabin temperature, the HVAC controller 115 may activate the evaporator 105 to cool the cabin 205 (e.g., the air blown into the cabin 205).

In some embodiments, the desired temperature (i.e., the desired cabin temperature) may be greater than a stale air temperature. The stale air temperature may be a temperature at which environmental conditions occur that may cause a stale air scent or smell in the cabin 205. According to one exemplary embodiment, the stale air temperature is approximately 10° C. According to other exemplary embodiments, the stale air temperature may differ. Where the desired temperature is greater than the stale air temperature, the evaporator 105 may thus cool air surrounding or otherwise moving or blown across the evaporator 105 to a temperature greater than the stale air temperature.

The system 100 is shown to include an ionizer 110. The ionizer 110 may be any device, component, or group of devices or components configured to ionize (or electrically charge) particulates, molecules, or other particles carried in the air passing through the system. According to an exemplary embodiment, the ionizer 110 is arranged downstream from the evaporator 105 in the system 100 (as shown in FIG. 2). The ionizer 110 may be configured to electrically charge airborne particles within the air from the evaporator 105. The airborne particles may cause the stale air smell resulting from the environmental conditions caused by the evaporator 105 cooling the air to a temperature above 10° C. The ionizer 110 may introduce negative (e.g., negatively charged) ions into the air. Airborne particles may become electrically charged as they attract the charged ions by electrostatic attraction. The electrically charged airborne particles may then become attracted to ground conductors. Such ground conductors may be arranged in the ionizer 110, in the ducts 210, etc. As air is blown by the blower 200 across the evaporator 105 and into the cabin 205, the ionizer 110 may be configured to ionize the airborne particles, which may be attracted to ground conductors. The airborne particles may “stick” to the ground conductors prior to the air being disbursed into the cabin 205. Thus, the ionizer 110 may generally cause the airborne particles causing the stale air smell to be removed from the air prior to the air being disbursed in the cabin 205. The ionizer 110 may function in accordance with, selected based on, or provide compliance to various standards, such as standards set by the American National Standards Institute (ANSI). The ionizer 110 may be selected based on such standards (e.g., ANSI/ESD STM3.1, ANSI/ESD SP3.3, etc.). The ionizer 110 may be selected to limit production of ozone.

The HVAC controller 115 may be configured to selectively enable, turn on, power or otherwise activate the ionizer 110 to ionize the air prior to the air being disbursed in the cabin 205. The HVAC controller 115 may be configured to selectively activate the ionizer 110 based on a temperature (or rate of change of temperature) of the air downstream from the evaporator 105. In some embodiments, the HVAC controller 115 may determine the temperature (or rate of change of temperature) of the air downstream from the evaporator 105 based on the climate control settings provided by the user (e.g., to the climate control system). In some embodiments, the system 100 may include one or more temperature sensor(s) 120. The temperature sensor(s) 120 may be arranged downstream from the evaporator 105. The temperature sensor(s) 120 may be configured to detect, assess, identify, or otherwise generate data corresponding to a temperature of air downstream from the evaporator 105 (e.g., an exit temperature of air from the evaporator 105). The temperature sensor(s) 120 may provide such data to the HVAC controller 115. In some embodiments, the temperature sensor(s) 120 may provide (or the HVAC controller 115 may determine) a rate of change of the exit temperature. The temperature sensor(s) 120 may generate a dataset (e.g., a number of temperature data samples) corresponding to the exit temperature. The temperature sensor(s) 120 and/or HVAC controller 115 may determine the rate of change of exit temperature based on the temperature data samples and the sample rate.

The HVAC controller 115 is shown to include an ionizer control circuit 125. The ionizer control circuit 125 may various components, such as processors, memory, instructions stored on memory, etc., which are configured to cause the HVAC controller 115 to perform various functions. While the following description may describe the ionizer control circuit 125 as performing various functions for purposes of brevity, it should be understood that the ionizer control circuit 125 may include, for instance, processors, memory, executable instructions stored on memory, etc., which cause the HVAC controller 115 to perform the corresponding functions.

The ionizer control circuit 125 may be configured to cause the ionizer 110 to operate when a sensed state of air blown across the evaporator indicates one or more predetermined conditions are present, including but not limited to the temperature of the air, the presence of particles, or a variety of other factors, several of which are discussed in detail below. It should be noted that while the following examples are discussed individually, according to some embodiments, the operation of the ionizer 110 may be triggered by a combination of these conditions (e.g., when a temperature exceeds the stale air threshold temperature and the presence of certain types of particles are detected in the air).

According to one exemplary embodiment, the ionizer control circuit 125 may be configured to cause the HVAC controller 115 to compare the exit temperature of air downstream from the evaporator 105 to a stale air threshold. The stale air threshold may be a threshold which corresponds to the stale air temperature. In some embodiments, the stale air threshold may be the stale air temperature (or the temperature at which the environmental conditions occur causing the stale air smell in the cabin). In some embodiments, the stale air threshold may be a rate of change of exit temperature indicating the exit temperature will exceed the stale air temperature. The ionizer control circuit 125 may receive the exit temperature from the temperature sensor(s) 120. The stale air threshold may be stored, located on, or otherwise included in the ionizer control circuit 125 (on memory, for instance). As described above, the stale air temperature may be approximately 10° C. according to one particular exemplary embodiment (or may differ according to other exemplary embodiments). Hence, in embodiments where the stale air threshold is a rate of change of exit temperatures for the evaporator, the rate of change may correspond to a rising exit temperature which indicates the evaporator discharge (or exit) temperature will rise above the stale air temperature.

The ionizer control circuit 125 may determine whether the exit temperature (or rate of change of temperature) from the temperature sensor(s) 120 exceeds than the stale air threshold. The ionizer control circuit 125 may activate the ionizer 110 to ionize the air downstream from the evaporator 105 when the exit temperature (or rate of change of temperature) exceeds the stale air threshold. Thus, the ionizer 110 may ionize the air corresponding to the exit temperature (e.g., when the exit temperature or rate of change of temperature exceeds the stale air threshold).

According to another exemplary embodiment, the ionizer control circuit 125 may be configured to cause the HVAC controller 115 to monitor an air quality of the air downstream from the evaporator 105 and/or in the cabin 205. The system 100 is shown to include one or more air quality sensor(s) 130. The air quality sensor(s) 130 may be any device, component, or group of devices or components configured to detect specific particles in air. The air quality sensor(s) 130 may include electrochemical cells designed to generate, produce, or otherwise output electrical signals (e.g., voltage, current, etc.) when in the presence of specific particles in the air. The electrochemical cells may be designed or implemented to react to nitrogen oxides, sulfur oxides, methane, ozone, carbon dioxide, carbon monoxide, hydrocarbons, etc. Such particles may be present in the air because of, for instance, vehicles which use diesel fuel in proximity to the electrochemical cells, unburnt fuel or incomplete combustion, proximity to various animals (such as skunks), etc. Hence, the air quality sensor(s) 130 may detect nitrogen oxides, sulfur oxides, methane, ozone, carbon dioxide, carbon monoxide, hydrocarbons, etc. In some embodiments, several air quality sensor(s) 130 may be arranged downstream from the evaporator 105 and/or in the cabin 205 to detect each (or a subset) of such particles.

According to another exemplary embodiment, the ionizer control circuit 125 may be configured to cause the HVAC controller 115 to activate the ionizer 110 when the presence of various particles (such as nitrogen oxides, sulfur oxides, methane, ozone, carbon dioxide, carbon monoxide, hydrocarbons, etc.) are detected in the air downstream from the evaporator 105 and/or in the cabin 205. The ionizer control circuit 125 may receive data from the air quality sensor(s) 130 which corresponds to the presence or absence of such particles in the air. In some embodiments, the ionizer control circuit 125 may receive data from the air quality sensor(s) 130 corresponding to the concentration of such particles in the air. The ionizer control circuit 125 may activate the ionizer 110 when the presence of such particles is detected, when the concentration exceeds an air quality threshold, etc.

According to other exemplary embodiments, the ionizer control circuit 125 may activate the ionizer 110 based on a mode for the HVAC system 100. For instance, the HVAC system 100 may have several modes, such as recirculation mode, fresh air mode, etc. In the recirculation mode, air from inside the cabin 205 is recirculated through the HVAC system 100, heated or cooled, and re-disbursed into the cabin 205. In the fresh air mode, air from outside the vehicle is drawn into the vehicle, heated or cooled via the HVAC system 100, and disbursed into the cabin 205. The ionizer control circuit 125 may, for example, active the ionizer 110 whenever the HVAC system 100 is in the recirculation mode such that the air recirculated in the cabin 205 is ionized to remove such particles (e.g., as detected by the air quality sensor(s) 130). According to other exemplary embodiments, the ionizer 110 may be activated any time that the HVAC system is operated, regardless of other factors.

The ionizer control circuit 125 may be configured to cause the HVAC controller 115 to monitor the exit temperature (or rate of change of temperature) of the air downstream from the evaporator 105 at intervals for activating and deactivating the ionizer 110. The HVAC control system 115 may include a clock 135. The clock 135 may be a circuit or device configured to generate a signal which can be used for monitoring a duration or otherwise measuring time. For instance, the clock 135 may be a signal generator configured to generate a sinusoidal wave with predetermined or pre-known characteristics, such as frequency, period, pulse width, etc. In some instances, the clock 135 may be an electronic oscillator regulated by a crystal, such as quartz. The clock 135 may generate a temporal signal which may be used by the HVAC controller 125 for measuring time.

In some implementations, the ionizer control circuit 125 may monitor the duration the ionizer 110 is active. The ionizer control circuit 125 may monitor the exit temperature (or rate of change of temperature) of the air downstream from the evaporator 105 at intervals while the ionizer 110 is active. For instance, the ionizer control circuit 125 may compare the duration the ionizer 110 is active to a time threshold (e.g., 5 seconds, 10 seconds, 20 seconds, one minute, etc.). The ionizer control circuit 125 may re-sample the exit temperature (or rate of change of temperature) when the duration the ionizer 110 is active exceeds the time threshold. In some embodiments, the ionizer control circuit 125 may re-sample the exit temperature (or rate of change of temperature) in real-time or near real-time (e.g., according to a sample rate of the temperature sensor(s) 120). In each of these implementations, the ionizer control circuit 125 may then compare re-sampled exit temperature (or rate of change of temperature) to the stale air threshold. The ionizer control circuit 125 may then selectively deactivate the ionizer 110 based on the comparison (e.g., when the re-sampled exit temperature is less than the stale air threshold). In this regard, the ionizer control circuit 125 may dynamically control the ionizer 110 based on the exit temperature downstream from the evaporator 105.

In some embodiments, the ionizer control circuit 125 may monitor a battery charge level for the vehicle. The ionizer control circuit 125 may be configured to automatically deactivate the ionizer 110 based on the battery charge level. For instance, where the vehicle is an electric vehicle, the ionizer control circuit 125 may determine when the battery charge level drops below a threshold. The threshold may correspond to a low battery charge level, at or approaching critical battery charge level, etc. The ionizer control circuit 125 may automatically deactivate the ionizer 110 when the battery charge level drops below the threshold to conserve range of the electric vehicle. Hence, the ionizer control circuit 125 may dynamically control the ionizer 110 based on the battery charge level.

In some embodiments, the system 100 includes a heater 125. The heater 125 may be arranged downstream from the evaporator 105 including, for instance, downstream from the ionizer 110. The HVAC controller 115 may be configured to provide commands or control signals to the heater 125 for heating air downstream from the evaporator 105. For instance, the HVAC controller 115 communicates signals to the heater 125 for heating air to the desired cabin temperature set by an occupant of the vehicle. The HVAC controller 115 may control the heater 125 for further regulating the temperature of the cabin, according to various embodiments.

Now that various aspects of the system 100 have been disclosed, a method of controlling an HVAC system (e.g., system 100) is now described. The following method is only one embodiment of a method of controlling an HVAC system. Various operations and steps are described with reference to the following method. However, the present disclosure is not limited to the following operations and steps. To the contrary, various steps and operations may be omitted, modified, and additional steps may be included in the method. Some steps and operations may be performed at the same time.

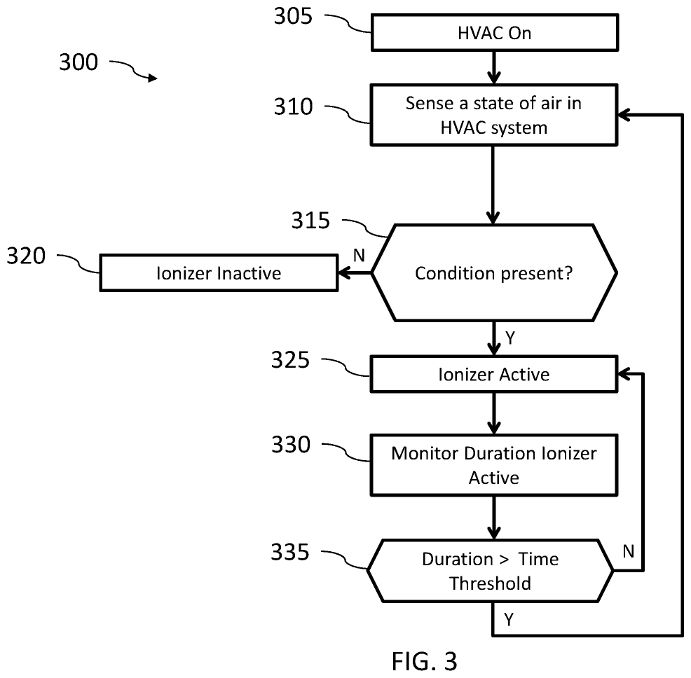

Referring now to FIG. 3, a flowchart showing an example method 300 of controlling an HVAC system (such as HVAC system 100) is shown, according to an exemplary embodiment.

At operation 305, the HVAC system 100 is “ON”, or in an active state. The HVAC system 100 may be on responsive to a user, such as an occupant of a vehicle, controlling the climate control system in the vehicle. The user may provide a desired temperature to the climate control system. The user may provide a defrost or dehumidification input to the climate control. The HVAC controller 115 may correspondingly activate one or more components of the HVAC system 100 (such as the evaporator 105) when the HVAC system 100 is turned on. In some embodiments, the HVAC controller 115 may automatically deactivate one or more components when the HVAC system 100 is turned on. For instance, the HVAC system 100 may be in an active state and operating in a cooling mode. While the HVAC system 100 is in a cooling mode, in some embodiments, the HVAC controller 115 may automatically deactivate the heater 125. The method 300 may proceed to operation 310.

At operation 310, the HVAC controller 115 may sense a state of air in the HVAC system 100. In some embodiments, the HVAC controller 115 receives data from sensor(s) arranged in the HVAC system 100 to determine the state of the air blown across the evaporator 105 or generally within the HVAC system 100 including, but not limited to, blown out of the HVAC system 100, introduced into the HVAC system 100, etc. The HVAC controller 115 may determine the state of the air based on data generated by the sensor(s) and provided to the HVAC controller 115.

In some embodiments, the HVAC controller 115 determines the exit temperature of air downstream from the evaporator 105. The HVAC controller 115 may determine the exit temperature of the air downstream from the evaporator based on data provided by the temperature sensor(s) 120. The temperature sensor(s) 120 may be arranged downstream from or otherwise configured to sense air temperature downstream from the evaporator 105. In some embodiments, the exit temperature may be a rate of change of the exit temperature. The HVAC controller 115 and/or temperature sensor(s) 120 may determine the rate of change of exit temperatures based on a set temperature data samples and a sample rate of the temperature sensor(s) 120.

In some embodiments, the HVAC controller 115 detects a quality of the air in the environment (e.g., in the cabin 205). The HVAC controller 115 may receive data from the air quality sensor(s) 130. The air quality sensor(s) 130 may generate data corresponding to the presence of or concentration of various particles in the air, such as nitrogen oxides, methane, ozone, carbon dioxide, etc. The HVAC controller 115 may detect the quality of air (e.g., whether the air includes the various particles, whether the air includes a concentration of the various particles exceeding an air quality threshold, etc.).

At operation 315, the HVAC controller 115 may determine whether a condition is present. The condition may prompt activation of the ionizer 110. The HVAC controller 115 may determine whether the condition is present based on the state of the air (e.g., determined at operation 310).

In some embodiments, the condition is the exit temperature exceeding a stale air threshold. In other embodiments, the condition is a rate of change of the exit temperature exceeding the stale air threshold. The HVAC controller 115 may compare the exit temperature or the rate of change of exit temperature to the stale air threshold. The HVAC controller 115 may store or otherwise include the stale air threshold. The stale air threshold may be a threshold which corresponds to the stale air temperature. In some embodiments, the stale air threshold may be the stale air temperature (or the temperature at which the environmental conditions occur causing the stale air smell in the cabin). In some embodiments, the stale air threshold may be a rate of change of exit temperature indicating the exit temperature will exceed the stale air temperature (for instance, 10° C.). The HVAC controller 115 may compare the determined exit temperature or rate of change of exit temperature to the stale air threshold. The HVAC controller 115 may determine that the condition is present based on such comparisons.

In some embodiments, the condition is particles detected in the air. The particles may be, for instance, nitrogen oxides, methane, ozone, carbon dioxide, etc. In some embodiments, the condition is a number of particles (e.g. a concentration) detected in the air exceeding an air quality threshold. The HVAC controller 115 may store the air quality threshold. The HVAC controller 115 may identify whether any particles are present in the air based on the state of the air as detected by the air quality sensor(s) 125. In embodiments where the condition is the concentration of particles exceeding the air quality threshold, the HVAC controller 115 may identify whether the state (e.g., particle concentration) detected via the air quality sensor(s) 125 exceeds the air quality threshold.

In some embodiments, the condition is the air being conditioned by the HVAC system 100. The condition may be the air being cooled by the HVAC system 100. For instance, the HVAC controller 115 may determine a state of the air (e.g., that the air is being “conditioned”, or heated, cooled, blown, re-circulated, etc. within the vehicle by the HVAC system 100) based on a mode of the HVAC system 100. The HVAC controller 115 may retrieve and/or maintain a status or mode of the HVAC system 100. The HVAC controller 115 may determine the condition is present when the HVAC system 100 is operating in an active mode, recirculation mode, cooling mode, etc.

In some embodiments, the condition is the air being conditioned by the HVAC system 100 and the exit temperature exceeding the stale air threshold. In some embodiments, the condition is the exit temperature exceeding the stale air threshold and particles being present in the air. In some embodiments, the condition is the air being cooled by the HVAC system 100 and a concentration of particles in the air exceeding an air quality threshold. In this regard, the condition may include two or more of the aforementioned conditions corresponding to different states.

When the HVAC controller 115 determines the condition is not present, the method 300 proceeds to operation 320 where the HVAC controller 115 maintains the ionizer 110 as inactive or deactivates the ionizer 110 if the ionizer 110 was operating. Where the HVAC controller 115 determines the condition is present, the method 300 proceeds to operation 325.

At operation 325, the HVAC controller 115 activates the ionizer 110. The ionizer 110 may be arranged downstream from the evaporator 105. The ionizer 110 may ionize the air from the evaporator 110 prior to the air being disbursed into the environment (e.g., the cabin 205). The ionizer 110 may be configured to electrically charge airborne particles within the air from the evaporator 105. The airborne particles may cause the stale air smell resulting from the environmental conditions caused by the evaporator 105 cooling the air to a temperature above 10° C. The ionizer 110 may introduce negative (e.g., negatively charged) ions into the air. Airborne particles may become electrically charged as they attract the charged ions by electrostatic attraction. The electrically charged airborne particles may then become attracted to ground conductors. Such ground conductors may be arranged in the ionizer 110, in the ducts 210, etc. As air is blown by the blower 200 across the evaporator 105 and into the cabin 205, the ionizer 110 may be configured to ionize the airborne particles, which may be attracted to ground conductors. The airborne particles may “stick” to the ground conductors prior to the air being disbursed into the cabin 205. Thus, the ionizer 110 may generally cause the airborne particles causing the stale air smell to be removed from the air prior to the air being disbursed in the cabin 205.

In some embodiments, the HVAC controller 115 may activate the ionizer 110 based on the exit temperature (or rate of change of exit temperature) of air downstream from the evaporator and/or based on the detected quality of the air. For instance, the HVAC controller 115 may activate the ionizer 110 when the detected air quality (based on data from the air quality sensor(s) 130) indicates particles in the air, and/or when the exit temperature or rate of change of exit temperature exceeds the stale air threshold. In some embodiments, the HVAC controller 115 may activate the ionizer 110 based on the detected air quality indicates particles in the air when the HVAC system 100 is in a particular mode (such as, for instance, recirculation mode).

At operation 330, the HVAC controller 115 may monitor a duration that the ionizer 110 is active. The HVAC controller 115 may monitor the duration that the ionizer 110 is active using a temporal signal generated by the clock 135. In some embodiments, the HVAC controller 115 may monitor the duration that the ionizer 110 is active while the HVAC system 100 is active. For instance, the HVAC controller 115 may monitor both the duration that the ionizer 110 is active and monitor the state of the HVAC system 100. The method 300 may proceed to operation 335.

At operation 335, the HVAC controller 115 may compare the duration that the ionizer 110 is active to a time threshold. In some embodiments, the time threshold may be 10 seconds. In some embodiments, operation 330 and operation 335 may be a sampling rate for the HVAC controller 115. Where the duration is less than the time threshold, the method 300 may loop back to operation 325 (e.g., where the ionizer 110 is maintained in an active state). In instances where the HVAC system 100 is deactivated prior to the duration that the ionizer 110 is active exceeding the threshold, the method 100 may proceed directly to operation 320 where the ionizer 110 is deactivated. Where the duration is greater than the time threshold, the method 300 may loop back to operation 310 (e.g., where the HVAC controller 115 determines a state of the air in the HVAC system 100).

In some embodiments, the HVAC controller 115 may deactivate the ionizer 110 responsive to the duration exceeding the time threshold. Hence, the HVAC controller 115 may deactivate the ionizer 110 following a duration of time that the ionizer 110 is active.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps. It is important to note that the construction and arrangement of the [apparatus, system, assembly, etc.] as shown in the various exemplary embodiments is illustrative only. Additionally, any element disclosed in one embodiment may be incorporated or utilized with any other embodiment disclosed herein.

What is claimed is:

1. An HVAC system for a vehicle comprising:
an evaporator configured to cool air;
an ionizer disposed in the system downstream from the evaporator and configured to ionize the cool air prior to disbursing the cool air into an environment;
a heater arranged downstream from the evaporator; and
an HVAC controller communicably coupled to the evaporator, the heater and the ionizer, the HVAC controller configured to:
while the HVAC system is operating in cooling mode,
deactivate the heater;
determine an exit temperature of air from the evaporator;
compare the determined exit temperature to a stale air threshold; and
responsive to the determined exit temperature exceeding the stale air threshold, activate the ionizer to ionize the air from the evaporator prior to the air being disbursed into the environment.

2. The system of claim 1, wherein determining the exit temperature of the air from the evaporator comprises determining a rate of change of the exit temperature, and wherein the stale air threshold is a rate of change of temperature corresponding to the exit temperature exceeding a stale air temperature.

3. The system of claim 2, wherein the stale air temperature is 10° C.

4. The system of claim 1, wherein the HVAC controller is further configured to:
while the ionizer is active, monitor a duration which the ionizer is active;
compare the duration the ionizer is active to a time threshold; and
responsive to the duration exceeding the time threshold, deactivating the ionizer.

5. The system of claim 1, further comprising:
an air quality sensor disposed in the HVAC system downstream from the evaporator and communicably coupled to the HVAC controller;
wherein the HVAC controller is further configured to:
detect, based on data from the air quality sensor, a quality of the air in the environment; and
activate the ionizer to ionize the air based at least in part on the detected quality of the air.

6. The system of claim 5, wherein the air quality sensor is configured to detect a presence of at least one of nitrogen oxides or methane.

7. The system of claim 5, wherein the HVAC controller is further configured to:
determine whether the HVAC system is in recirculation mode; wherein
the HVAC controller is configured to activate the ionizer based on the detected quality of the air when the HVAC system is in recirculation mode.

8. The system of claim 1, further comprising:
a temperature sensor disposed downstream from the evaporator; wherein the HVAC controller is configured to determine the exit temperature of the air from the evaporator based on data from the temperature sensor.

9. The system of claim 1, wherein the HVAC controller is further configured to:
determine, while the ionizer is activated and following a duration of time, the exit temperature of the air from the evaporator;
compare the exit temperature to the stale air threshold; and
responsive to the exit temperature being less than the stale air threshold, deactivating the ionizer.

10. A method of controlling an HVAC system comprising:
while the HVAC system is operating in a cooling mode,
deactivating a heater arranged in the HVAC system arranged downstream from an evaporator;
determining a state of air in the HVAC system;
determining, based on the state of the air, whether a condition is present which prompts activation of an ionizer; and
responsive to the condition being present, activating the ionizer arranged downstream from the evaporator, the ionizer ionizing the air from the evaporator prior to the air being disbursed into the environment.

11. The method of claim 10, wherein the state is an exit temperature of the air, and wherein the condition is the temperature exceeding a stale air threshold.

12. The method of claim 11, determining the state of the air blown across the evaporator comprises determining a rate of change of the exit temperature of the air downstream from the evaporator, and wherein the stale air threshold is a rate of change of temperature corresponding to the exit temperature exceeding a stale air threshold.

13. The method of claim 10, further comprising:
while the ionizer is active, monitoring a duration which the ionizer is active;
comparing the duration the ionizer is active to a time threshold; and
responsive to the duration exceeding the time threshold, deactivating the ionizer.

14. The method of claim 10, wherein the state of the air is a quality of the air.

15. The method of claim 14, further comprising:
determining whether the HVAC system is in recirculation mode,
wherein the activating the ionizer to ionize the air comprises:
activating the ionizer to ionize the air based at least in part on the detected quality of the air responsive to the HVAC system being in recirculation mode.

16. The method of claim 10, further comprising:
determining, while the ionizer is activated and following a duration of time, the state of the air blown across the evaporator;
determining, based on the state of the air, whether the condition is still present; and
responsive to the condition no longer being present, deactivating the ionizer.

17. A method of controlling an HVAC system comprising:
while an HVAC system is operating in a cooling mode,
a) deactivate a heater arranged downstream from an evaporator in the HVAC system;
b) determining an exit temperature of air downstream from the evaporator;
c) comparing the exit temperature to a stale air threshold;
d) when the determined exit temperature exceeds a stale air threshold,
activating an ionizer to ionize air downstream from the evaporator prior to the air being disbursed into the environment;
monitoring a duration which the ionizer is active; and
when the duration exceeds a time threshold, repeating steps b) through c) until the exit temperature is less than the stale air threshold, whereby the ionizer is deactivated when the exit temperature is less than the stale air threshold.

18. The method of claim 17, wherein determining the exit temperature of the air downstream from the evaporator comprises determining a rate of change of the exit temperature of the air downstream from the evaporator, and wherein the stale air threshold is a rate of change of temperature corresponding to the exit temperature exceeding a stale air temperature.

19. The method of claim 17, further comprising:
detecting, based on data from an air quality sensor disposed downstream from the evaporator, a quality of the air in the environment;
wherein the activating the ionizer to ionize the air comprises:
activating the ionizer to ionize the air downstream from the evaporator prior to the air being disbursed into the environment when the exit temperature exceeds the stale air threshold and based at least in part on the detected quality of the air.

20. The method of claim 19, further comprising:
determining whether the HVAC system is in recirculation mode,
wherein the activating the ionizer to ionize the air comprises:
activating the ionizer to ionize the air downstream from the evaporator prior to the air being disbursed into the environment when the exit temperature exceeds the stale air threshold and based at least in part on the detected quality of the air responsive to the HVAC system being in recirculation mode.
